(19) United States
(12) Patent Application Publication
(10) Pub. No.: US 2007/0212552 A1
(43) Pub. Date: Sep. 13, 2007

(54) Roll Cover and Method of Manufacturing Roll Including the Roll Cover

(75) Inventors: Keigo Goshiki, Saitama (JP); Shinnya Abe, Ibaraki (JP)

Correspondence Address: COLLEN IP, THE HOLYOKE MANHATTAN BUILDING, 80 SOUTH HIGHLAND AVENUE, OSSINING, NY, 10562, US

(73) Assignee: Junkosha Inc., Ibaraki-ken (JP)

(21) Appl. No.: 11/569,964

(22) PCT Filed: May 24, 2005
(86) PCT No.: PCT/JP05/09831

§ 371 Date: Dec. 2, 2006

(30) Foreign Application Priority Data
Jun. 2, 2004 (JP) 2004-164380

(51) Int. Cl. B32B 27/30

(52) U.S. Cl. 428/421; 264/240

(57) ABSTRACT

A roll cover of the invention has at least first and second layers, the first layer is formed of a thermoplastic fluoropolymer without including a hydroxyl group, and the second layer is formed of a thermoplastic fluoropolymer including a hydroxyl group, an outer circumferential face (first layer) of the roll cover has a nonsticky property, and an inner circumferential face (second layer) of the roll cover can be adhered to a roll body with sufficient adhesion strength without performing dangerous and complicated chemical inside treatment, and a roll cover excellent in adhesion stability with time can be given. As a result, the chemical inside treatment is unnecessary in a manufacturing process of the roll cover, consequently productivity of the roll cover can be significantly improved.

### TECHNICAL FIELD

The present invention relates to a roll cover configuring a part of a roll used for, for example, a heat fixing roll or a pressure roll in a copying machine or a printer, and a method of manufacturing a roll including the roll cover.

### BACKGROUND ART

A copying machine or a printer has a heat-roll-type fixing device performing heat fixing of toner, and that fixing device has, for example, a heat fixing roll, a pressure roll pressed by the heat fixing roll, or the like (hereinafter, called “roll”) arranged therein. Such a roll is configured by a rod-like roll body and a tubular roll cover covering an outer circumferential face of the roll body, and the roll cover is adhered to the outer circumferential face of the roll body.

Since the outer circumferential face of the roll (roll cover) is required to have a nonsticky property to toner or a recording medium such as paper, a fluoropolymer having properties such as heat resistance and the nonsticky property is appropriate for a material of that roll cover, a tubular body (tube) consisting of the fluoropolymer is typically used for the roll cover. On the other hand, since the fluoropolymer originally has a nonadhesive property, in order to adhere the tubular body (roll cover) consisting of the fluoropolymer to the roll body, an inner circumferential face of a tubular roll cover (inside of the tubular body) must be first subjected to surface treatment before the tubular body is adhered to the roll body with an adhesive.

Such inside treatment of the tubular body consisting of the fluoropolymer is described in, for example, JP-A-10-60139, and an extremely complicated treatment has been usually performed that a solution of sodium (alkaline metal) and naphthalene complex dissolved in organic solvent, or a liquid ammonia solution of sodium (alkaline metal) dissolved in liquid ammonia is contained within the tubular body to perform chemical inside treatment, and furthermore the inside of the tubular body is washed with alcohol, water, and acetone.

The conventional roll cover consisting of the fluoropolymer has been required to be subjected to the inside treatment of the roll cover to adhere the roll cover to the roll body, as described before. The inside treatment is dangerous because metallic sodium is used, and in addition, it requires a washing step using alcohol, water and acetone, leading to significant reduction in productivity of the roll cover due to such an extremely complicated inside treatment step.

JP-A-10-60139 describes a method of a continuous inside treatment method of a fluorinated resin tube, which enables continuous treatment, brings excellent productivity and workability, and does not cause deterioration in treatment liquid or production of a treatment spot, in addition, may use a liquid ammonia solution of alkaline metal, the solution having not been able to be used in a conventional continuous treatment method because it has high volatility while exhibiting a high treatment effect. However, since in the continuous inside treatment method using the liquid ammonia solution, a low temperature condition is necessary for inside treatment, large-scale equipment is required.

While the method of using the solution of sodium (alkaline metal) and naphthalene complex dissolved in organic solvent can be easily practiced compared with the method of using the liquid ammonia solution of alkaline metal, that method has a disadvantage that activity of a treated surface is reduced with time by, for example, heat or ultraviolet rays, as a result adhesion to the roll body is reduced.

Furthermore, when the roll cover is used in a place to be heated to high temperature (about 200° C.) such as the heat fixing roll, there has been a difficulty in adhesion stability, that is, strength of adhesion to the roll body is reduced with time, consequently the roll cover is separated from the roll body.

Still furthermore, the treatment of sequentially washing the inside of the tubular body with alcohol, water and acetone is necessary after the chemical inside treatment, consequently productivity of the roll cover is significantly reduced, and in addition, there has been a fear that when the chemical inside treatment is performed, a surface of the tube is damaged, rimpled, or creased by, for example, a fact that the tubular body is pinched by pinch rollers, consequently print quality is reduced by the roll cover.

### DISCLOSURE OF THE INVENTION

The invention was made from the above circumstance, and a first object of the invention is to provide a roll cover consisting of a fluoropolymer, the roll cover being excellent in productivity, being able to be adhered to a roll body with sufficient adhesion strength without performing dangerous and complicated chemical inside treatment of the roll cover, and having excellent adhesion stability with time.

A second object of the invention is to provide a method of manufacturing a roll, in which productivity of a roll cover is excellent, the roll body can be adhered to the roll cover with sufficient adhesion strength without dangerous and complicated chemical inside treatment of the roll cover, and adhesion stability with time is excellent.

To achieve the first object, the roll cover of the invention, which covers a rod-like roll body, and is formed of a thermoplastic fluoropolymer, is characterized in that the roll cover has at least first and second layers, the first layer is formed of a thermoplastic fluoropolymer without including a hydroxyl group and configures an outer circumferential face of the roll cover, and the second layer is formed of a thermoplastic fluoropolymer including the hydroxyl group and configures an inner circumferential face of the roll cover.

Accordingly, since the first layer configuring the outer circumferential face is formed of the thermoplastic fluoropolymer without including the hydroxyl group, the outer circumferential face of the roll cover has the nonsticky property, while since the second layer configuring the inner circumferential face to be contacted to the roll body is formed of the thermoplastic fluoropolymer including the hydroxyl group, it can be adhered to the roll body without the chemical inside treatment using the organic solvent having the complex of alkaline metal dissolved therein or the liquid ammonia solution of alkaline metal. As a result, a manufacturing process of the roll does not require a step of the dangerous and complicated chemical inside treatment using the organic solvent having the complex of alkaline metal dissolved therein or the liquid ammonia solution of alkaline metal, and consequently productivity of the roll cover can be significantly improved and production cost of the roll can be reduced.

Furthermore, since the chemical inside treatment is not required, the problem of separation of the roll cover from the roll body can be solved without causing reduction in adhesion stability with time at high temperature.

The roll cover of the invention is characterized in that the first layer is formed of per-fluoroalkoxyalkane polymer (PFA) without including the hydroxyl group, and the second layer is formed of a copolymer of a fluoro-monomer having the hydroxyl group, tetrafluoroethylene, and per-fluoro-alkylvinylether. Since the first and second layers are melted to be unified by, for example, two-layer extrusion molding, the first and second layers are firmly bonded, and furthermore a roll cover having excellent durability and heat resistance can be provided.

Furthermore, the roll cover of the invention is characterized in that the first layer is formed of a thermoplastic fluoropolymer having a melt flow rate (MFR) of 10 or less, the melt flow rate being measured by a method defined in AMERICAN SOCIETY FOR TESTING AND MATERIALS (ASTM) D 3307.

Accordingly, a roll cover having excellent durability can be further provided.

To achieve the second object, the method of manufacturing the roll of the invention which includes a roll body and a roll cover, is characterized in that, the roll body is covered with the roll cover according to claims 1 to 3, and is subjected to heat treatment at a temperature of a glass transition point or more of the thermoplastic fluoropolymer forming the second layer of the roll cover and a melting point or less of the polymer.

Accordingly, since the roll cover can be sufficiently adhered to the roll body, the manufacturing process of the roll does not require the step of the dangerous and complicated chemical inside treatment using the organic solvent having the complex of alkaline metal dissolved therein or the liquid ammonia solution of alkaline metal, consequently productivity of the roll cover can be significantly improved. As a result, production cost of the roll can be reduced, and furthermore manufacturing equipment excellent in environmental measure can be achieved.

According to the invention, the roll cover consisting of the fluoropolymer can be provided, the roll cover being characterized in that it is excellent in productivity, and can be adhered to a roll body with sufficient adhesion strength without dangerous and complicated chemical inside treatment of the roll cover, and has excellent adhesion stability with time. Since the manufacturing process of the roll does not require the step of the chemical inside treatment, productivity of the roll can be significantly improved and production cost of the roll can be reduced.

Moreover, according to the invention, since the roll cover can be adhered to the roll body with sufficient adhesion strength although the chemical inside treatment is not performed, the manufacturing process of the roll does not require the step of the chemical inside treatment, thereby productivity of the roll can be significantly improved, and adhesion stability with time can be improved. Accordingly, production cost of the roll can be reduced, and the roll cover is not separated from the roll body during use at high temperature, consequently a long life of the roll can be achieved, and manufacturing equipment excellent in environmental measure can be provided.

### BRIEF DESCRIPTION OF THE DRAWINGS

FIG. 1 shows a perspective view showing a part of a roll 100 according to an embodiment of the invention; and

FIG. 2 shows a diagram along a line X-X shown in FIG. 1, which is a cross section view showing a cross section of the roll 100.

### BEST MODE FOR CARRYING OUT THE INVENTION

Hereinafter, an embodiment of a roll cover according to the invention, and a roll including the roll cover are described. The following embodiment is not intended to limit the invention according to the scope of claims, and all of combinations of features described in the embodiment are not necessarily indispensable for means for solving the problems of the invention.

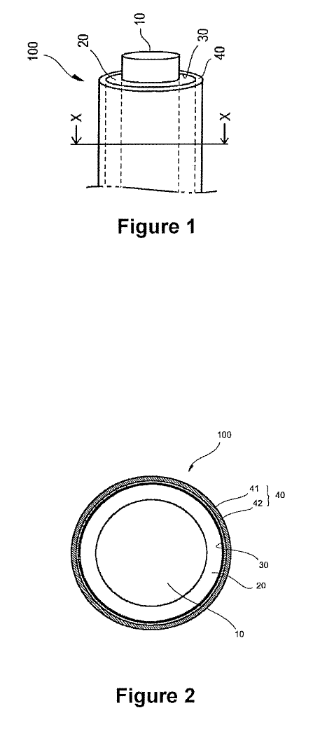

First, the embodiment of the invention is described with reference to FIGS. 1 and 2. FIG. 1 shows a perspective view showing a part of a roll 100 according to the embodiment of the invention. FIG. 2 shows a diagram along a line X-X shown in FIG. 1, which is a cross section view showing a cross section of the roll 100.

The roll 100 outlined in FIG. 1 is a roll used for a heat fixing roll or a pressure roll to be pressurized by the heat fixing roll of a copying machine, a printer and the like (hereinafter, referred to “recording device”), which is approximately configured by a cored bar 10, roll body 20, and roll cover 40 as shown in FIG. 1.

The cored bar 10 is a hollow or a solid rod consisting of a material such as metal, and preferably formed of aluminum, however, it may be formed of any material so long as the material can act as a core portion for supporting the roll 100.

The roll body 20 is a cylindrical elastic body formed with being adhered to an outer circumferential face of the cored bar 10, and preferably formed of silicon resin. However, the roll body 20 is not limited to the elastic body, and may be formed of metal or the like. While the roll body 20 and the cored bar 10 are configured respectively in the embodiment as shown in FIGS. 1 and 2, the roll 100 may be in a configuration where the cored bar 10 is used as the roll body 20 as described later.

The roll cover 40 is a tubular body formed around the roll body 20 (in the case of the roll 100 using the cored bar 10 as the roll body 20, the cored bar 10 acts as the roll body 20, and this is the same in the following) as shown in FIGS. 1 and 2, and configured by a first layer 41 forming an outer layer of the roll cover 40 and a second layer 42 forming an inner layer of the roll cover 40. The second layer 42 is adhered to the outer circumferential face of the roll body 20 with an adhesive layer 30 or primer between them. The second layer 42 may be directly adhered to the outer circumferential face of the roll body 20 without the adhesive layer 30 or the primer between them. Thus, the cored bar 10, roll body 20, and roll cover 40 are bonded to one another, and when the cored bar 10 is rotated with respect to an axial direction thereof, the roll cover 40 is also rotated with the cored bar 10 and the roll body 20 in a unified manner.

As described above, the roll cover 40 of the embodiment includes the first layer 41 forming the outer layer and the second layer 42 forming the inner layer, and the first layer 41 is formed of the thermoplastic fluoropolymer without including the hydroxyl group, and furthermore the second layer 42 is formed of the thermoplastic fluoropolymer including the hydroxyl group, therefore the conventional inside treatment of the roll cover can be omitted from a process of manufacturing the roll 100. Hereinafter, characterizing portions of the roll cover 40 according to the invention are described.

The inventors of the invention have earnestly conducted research and development on the roll cover using the thermoplastic fluoropolymer including the hydroxyl group as a material. As a result, the inventors found that the roll cover consisting of the thermoplastic fluoropolymer including the hydroxyl group was able to be adhered to the roll body 20 via the adhesive layer 30 or the primer or directly adhered to it at a certain condition without the surface treatment.

Thus, the inventors formed the first layer 41 at a side of the outer circumferential face of the roll cover 40 by the thermoplastic fluoropolymer without including the hydroxyl group, the first layer being to be contacted to a recording medium, and formed the second layer 42 by the thermoplastic fluoropolymer including the hydroxyl group, the second layer being to be adhered to the roll body 20 with or without the adhesive layer 30 or the primer between them. The thermoplastic fluoropolymer without including the hydroxyl group retains the nonsticky property.

Moreover, the inventors found that the roll cover 40 including the first layer 41 formed by the thermoplastic fluoropolymer without including the hydroxyl group and the second layer 42 formed by the thermoplastic fluoropolymer including the hydroxyl group was able to be produced by a typical two-layer extrusion process or the like, and furthermore found that the first layer 41 and the second layer 42 were fused and thus bonded in one.

Next, an example of a preferred configuration of the roll cover 40 according to the invention is described. First, the thermoplastic fluoropolymer without including the hydroxyl group usable for the first layer 41 configuring the outer layer of the roll cover 40 includes per-fluoroalkoxyalkane polymer (PFA), per-fluoro-ethylene-propylene copolymer, ethylene-tetrafluoroethylene copolymer, and polyvinylidene fluoride. Among them, per-fluoroalkoxyalkane polymer (PFA) or ethylene-tetrafluoroethylene copolymer (ETFE) is preferable from the viewpoint of durability, and per-fluoroalkoxyalkane polymer (PFA) is most preferable from additional viewpoints of the nonsticky property and heat resistance. The thermoplastic fluoropolymer without including the hydroxyl group forming the first layer 41 may be mixed with a carbon-based filler for adding conductivity.

When durability of the roll cover 40 is further pursued, it is preferable that a material of the first layer 41 has the melt flow rate (hereinafter, referred to “MFR”) of 10 or less, the melt flow rate being measured by the method defined in ASTM D3307. Moreover, MFR is preferably 0.2 or more to keep sufficient productivity in production by extruding of the roll cover 40.

Next, the diameter of the tube body used for the roll cover 40 can be optionally adjusted depending on size of the roll body 20. Moreover, while thickness of the roll cover 40 can be optionally selected depending on a type or a usage aspect of the roll 100, typically, it is preferably 10 to 300 μm, and more preferably 20 to 150 μm. Furthermore, regarding the thickness of the roll cover 40, thickness of the first layer 41 is preferably one third or more of the thickness of the roll cover 40 in the light of durability and wear resistance. Thickness of the second layer 42 is preferably 0.01 μm or more to secure sufficient strength of adhesion to the roll body 20.

The roll cover 40 may be or may not be in a type of contracting in a radial direction or an axial direction by heat. A type of contractility of the roll cover 40 can be optionally selected depending on the type or the usage aspect of the roll 100.

The thermoplastic fluoropolymer without including the hydroxyl group of the first layer 41 of the roll cover 40 can be obtained by copolymerization of a monomer including the hydroxyl group and a monomer without including the hydroxyl group. While examples of the monomer including the hydroxyl group are shown in the following formula 1, the monomers including the hydroxyl group are not limited to these, and other usable monomers including the hydroxyl group may be used.

Formula 1
CF₂═CF—R—CH₂—OH, CH₂═CH—R—CH₂—OH,
CF₂═CH—R—CH₂—OH, CF₂═CF—O—R—CH₂—OH,
CH₂═CH—O—R—CH₂—OH,
CF₂═CFCF₂—O—R—CH₂—OH,
CH₂═CFCF₂—R—CH₂—OH, and
CH₂═CFCF₂—O—R—CH₂—OH,

wherein R is one or a combination of at least 2 selected from a: —(CX₂)₁—, b: —(OCF(CF₃)CF₂)ₘ—, c: —(OCF₂CF(CF₃))ₘ—, d: —(OCF(CF₃))ₙ—, and e: —(OCF₂CF₂)ₙ—. X is H (hydrogen) or F (fluorine), and 1 is 0 to 40, m is 0 to 10, and n is 0 to 10.

As the monomer without including the hydroxyl group, one or a combination of at least two selected from ethylene, propylene, tetrafluoroethylene, hexafluoropropylene, per-fluoroalkylvinyl ether, chlorotrifluoroethylene, and vinylidene fluoride can be used. Preferably, a combination of tetrafluoroethylene and per-fluoroalkylvinyl-ether is excellent in the light of heat resistance.

Next, a method of manufacturing the roll cover 40 according to the invention is described. The roll cover 40 according to the invention can be manufactured by a typical two-layer extruding process. For example, two extruding machines in which a screw is provided in a cylinder having a heater are installed such that each material can be flown into a two-layer die, which is typically used, from each extruding machine. Then, the material of the first layer 41 and the material of the second layer 42 are extruded into the two-layer die from respective extruding machines, and distributed into two layers in the two-layer die. A molded body that has been distributed in two layers is shaped into desired size and form using a sizing die or the like. As a method of shaping the body into the desired size and shape, a method such as a vacuum sizing method, an inside mandrel method or the like can be also used.

Next, a manufacturing method of the roll 100 according to the invention is described. The manufacturing method of the roll 100 is based on conventionally practiced, manufacturing methods of a roll. As the conventional manufacturing methods of a roll, for example, the following three manufacturing methods are typically practiced.

In a first manufacturing method, for example, a roll body 20 including a layer of an elastic material such as silicone rubber, silicone foam, urethane rubber, or fluorine-contained rubber in a fixed thickness is formed on the periphery of a metallic cored-bar 10 in a central portion, then an adhesive layer 30 is provided on a surface of the roll body, and then the roll body 20 is covered by the roll cover 40.

In a second manufacturing method, for example, an adhesive layer 30 is directly provided around the metallic cored-bar 10 in the central portion, then the cored bar 10 is covered by the roll cover 40. That is, that method uses the cored bar 10 as the roll body 20 without forming the roll body 20, wherein the cored bar 10 is directly covered with the roll cover 40.

In a third manufacturing method, for example, the roll cover 40 is disposed around the metallic cored-bar 10 in the central portion such that a predetermined space is formed between them, then a material of the roll body 20, for example, non-vulcanized silicone rubber is flown into the space, and then the silicone rubber is vulcanized to form the roll body 20.

In the first to third manufacturing methods, when the roll body 20 (or cored bar 10) is adhered to the roll cover 40, primer may be used.

Next, characterizing portions of the manufacturing method of roll according to the invention are described. The inventors have conducted earnest study on a method by which the roll cover 40 according to the invention can be firmly adhered to the roll body 20. As a result, the inventors found that the roll cover 40 was preferably adhered to the roll body 20 at a temperature of the glass transition point or more of the thermoplastic fluoropolymer of the second layer 42 of the roll cover 40 and the melting point or less of the polymer.

That is, when the roll cover 40 is adhered to the roll body at a temperature of the glass transition point or less, sufficient adhesion strength is not obtained, or extremely long time is required for adhesion. When the roll cover is adhered to the roll body at a temperature of the melting point or more, the roll cover 40 is deformed, consequently a roll 100 having a flat, outer circumferential surface is hardly obtained.

Thus, the manufacturing method of the roll 100 according to the invention is characterized in that the roll body 20 is covered with the roll cover 40, and is subjected to heat treatment at the temperature of the glass transition point or more of the thermoplastic fluoropolymer forming the second layer 42 of the roll cover 40 and the melting point or less of the polymer. It is also acceptable that the roll 100 is produced by the third manufacturing method, then the roll 100 is subjected to the heat treatment at the temperature of the glass transition point or more of the thermoplastic fluoropolymer forming the second layer 42 of the roll cover 40 and the melting point or less of the polymer.

Next, examples of the invention are described.

### EXAMPLE 1

### Roll Cover A

PFA (Fluon (registered trademark) P-802UP manufactured by ASAHI GLASS CO., LTD., MFR=2.0) was selected for a material of the first layer, and a thermoplastic fluoropolymer including a hydroxyl group (NEOFLON (registered trademark) RAP manufactured by DAIKIN INDUSTRIES, LTD. (a glass transition point was 60° C. when a film 50 μm thick was measured by a tension dynamic viscoelastic test at a frequency of 0.25 Hz and an amplitude of 5 g)) was selected for a material of the second layer, then a two-layer extruding machine was used to obtain a roll cover A in a two-layer structure having the outer diameter of 29 mm, thickness of the first layer of 45 μm, and thickness of the second layer of 5 μm.

### EXAMPLE 2

### Roll Cover B

PFA (TEFLON (registered trademark) 445HPJ manufactured by DUPONTMITSUI FLUOROCHEMICALS, MFR=4.8) was selected for a material of the first layer, and a thermoplastic fluoropolymer including a hydroxyl group (a mixed material of NEOFLON (registered trademark) RAP manufactured by DAIKIN INDUSTRIES, LTD. and Fluon (registered trademark) P-62X manufactured by ASAHI GLASS CO., LTD. in a mixing ration of 1 to 1 by weight (a glass transition point was 68° C. when a film 30 μm thick was measured by a tension dynamic viscoelastic test at a frequency of 0.25 Hz and an amplitude of 3 g)) was selected for a material of the second layer, then the two-layer extruding machine was used to obtain a roll cover B in a two-layer structure having the outer diameter of 50 mm, thickness of the first layer of 50 μm, and thickness of the second layer of 20 μm.

### COMPARATIVE EXAMPLE

### Roll Cover C

PFA (Fluon (registered trademark) P-802UP manufactured by ASAHI GLASS CO., LTD., MFR=2.0) was used to obtain a roll cover C in a single layer structure having the outer diameter of 29 mm and thickness of 50 μm. Next, only an inner circumferential face of the roll cover C was subjected to surface treatment for 10 sec using a fluoropolymer surface treatment agent (TETRA-ETCH (registered trademark) manufactured by Junkosha Inc., liquid of a sodium/naphthalene complex dissolved in a solvent), and then sequentially washed by methanol, water, and acetone in this order, and then dried.

[Fabrication of Roll]

Aluminum cored-bars 10 were disposed in the center of a cylindrical die, then non-vulcanized silicone rubber mixed with predetermined vulcanizing agent and reinforcing agent was filled into the peripheries of the cored bars, and then the silicone rubber was vulcanized, so that roll bodies 20 were obtained. Next, adhesive silicone (TSE3877 manufactured by Toshiba Silicones) was coated on surfaces of the roll bodies 20 and thus adhesive layers 30 were formed, and then the outer sides of the adhesive layers were covered by the roll covers A to C, and then the roll bodies with the roll covers were left to stand at room temperature for a day, and then rolls were fabricated at respective conditions of 1) being subject to heat treatment for 1 hr at 100° C., 2) being subject to heat treatment for 30 min at 150° C., and 3) being not subject to heat treatment.

[Evaluation test] Adhesion strength test between roll body and roll cover and heat resistance test

A roll immediately after fabrication and a roll that has been left to stand for 1000 hr in a constant temperature oven at 230° C. were cut into pieces of 10 mm width and 100 mm length, then the roll body was partially separated from the roll cover, and then ends of them were pinched by chucks of a tensile testing machine respectively, and then adhesion strength was measured at tensile strength of 50 mm/min.

[Test Results]

Test results of the roll cover A of the example 1 are shown in Table 1.

TABLE 1
Test results of the roll cover A

| | Adhesion | Initial | Heat |
|---|---|---|---|
| | condition | adhesion strength | resistance test |
| 1 | 1 hr at 100° C. | 10 N (cohesive failure) | 10 N (cohesive failure) |
| 2 | 30 min at 150° C. | 10 N (cohesive failure) | 10 N (cohesive failure) |
| 3 | not subjected to | 1 N (boundary | not performed because |
| | heat treatment | separation) | of initial separation |

As shown in Table 1, in both cases of heat treatment at 100° C. for 1 hr, and heat treatment at 150° C. for 30 min, the roll cover A had initial adhesion strength of 10N which allows the roll cover to be provided as a roll cover used for a roll of a copying machine and the like, and furthermore it showed a good result in the heat resistance test. In this way, the roll cover A of the example 1 showed good adhesion results by being subjected to certain heat treatment.

Next, test results of the roll cover B of the example 2 are shown in Table 2.

TABLE 2
Test results of the roll cover B

| | Adhesion | Initial | Heat |
|---|---|---|---|
| | condition | adhesion strength | resistance test |
| 1 | 1 hr at 100° C. | 10 N (cohesive failure) | 10 N (cohesive failure) |
| 2 | 30 min at 150° C. | 10 N (cohesive failure) | 10 N (cohesive failure) |
| 3 | not subjected to | 1 N (boundary | not performed because |
| | heat treatment | separation) | of initial separation |

As shown in Table 2, in both cases of heat treatment at 100° C. for 1 hr, and heat treatment at 150° C. for 30 min, the roll cover B had initial adhesion strength of 10 N, and furthermore it showed a good result in the heat resistance test, as the roll cover A.

Next, test results of the roll cover C of the comparative example are shown in Table 3.

TABLE 3
Test results of the roll cover C

| Adhesion | Initial | Heat |
|---|---|---|
| condition | adhesion strength | resistance test |
| not subjected to | 10 N (cohesive | 0 N (boundary |
| heat treatment | failure) | separation) |

As shown in Table 3, while the roll cover C had initial adhesion strength of 10 N which allows the roll cover to be provided as the roll cover used for the roll of the copying machine and the like, it failed in the heat resistance test.

Hereinbefore, the embodiment and the examples of the invention have been described. According to the invention, the roll cover 40 consisting of the fluoropolymer can be provided, the roll cover being excellent in productivity, being able to be adhered to the roll body with sufficient adhesion strength without dangerous and complicated chemical inside treatment of the roll cover. Furthermore, since the chemical inside treatment is not required, there is no fear of reduction in adhesion stability with time at high temperature, consequently a long life of the roll can be achieved. Since a step of the chemical inside treatment is unnecessary in a manufacturing process of the roll cover 40, productivity of the roll cover 40 can be significantly improved, and furthermore production cost of the roll cover 40 can be reduced. Moreover, manufacturing equipment excellent in environmental measures can be provided.

The scope of the invention is not limited to the embodiment and the examples, and can be applied to other various embodiments unless they are contrary to description of claims. For example, while the roll cover 40 was in the two-layer structure including the first layer 41 and the second layer 42 in the embodiment of the invention, the roll cover 40 is not limited to the two-layer structure, and if the roll cover 40 is in a multilayer structure having at least the first and second layers, for example, a three-layer structure, in which a first layer includes a thermoplastic fluoropolymer without including a hydroxyl group, an intermediate layer includes a thermoplastic fluoropolymer including a carbon-based filler, and a second layer includes a thermoplastic fluoropolymer including a hydroxyl group, or a structure having at least 3 layers may be used.

Moreover, while the roll 100 has both the roll body 20 and the cored bar 10 in the embodiment, a configuration of using the cored bar 10 as the roll body 20, in which the cored bar 10 functions as the roll body 20, may be used.

The invention can be practiced by using the thermoplastic fluoropolymer including the hydroxyl group and the thermoplastic fluoropolymer without including the hydroxyl group. However, the relevant thermoplastic fluoropolymer including a hydroxyl group and/or the relevant thermoplastic fluoropolymer without including a hydroxyl group are not limited to the thermoplastic fluoropolymers illustrated in the specification, and may be any thermoplastic fluoropolymers if they are thermoplastic fluoropolymers usable for the invention.

### INDUSTRIAL APPLICABILITY

The roll cover according to the invention and the roll including the roll cover are used in a heat or pressure fixing portion of a copying machine, printer or the like, in addition, it can be used for roll products consisting of a fluoropolymer, the roll products being used in various fields. Moreover, the manufacturing method of a roll according to the invention can be used for manufacturing the roll products.

1. A tubular roll cover, which covers a rod-like roll body, and is formed of a thermoplastic fluoropolymer, characterized in that:
the roll cover has at least first and second layers,
the first layer is formed of a thermoplastic fluoropolymer without including a hydroxyl group and configures an outer circumferential face of the roll cover, and
the second layer is formed of a thermoplastic fluoropolymer including a hydroxyl group and configures an inner circumferential face of the roll cover.

2. The roll cover according to claim 1, characterized in that:
the first layer is formed of per-fluoroalkoxyalkane polymer (PFA) without including a hydroxyl group, and
the second layer is formed of a copolymer of a fluoro-monomer having a hydroxyl group, tetrafluoroethylene, and per-fluoro-alkylvinylether.

3. The roll cover according to claim 1 or 2, characterized in that:
the first layer is formed of a thermoplastic fluoropolymer having a melt flow rate (MFR) of 10 or less, the melt flow rate being measured by a method defined in ASTM D 3307.

4. A manufacturing method of a roll including a roll body and a roll cover, characterized in that:
the roll body is covered with the roll cover according to claims 1 to 3, and
the roll body with the roll cover is subjected to heat treatment at a temperature of a glass transition point or more of the thermoplastic fluoropolymer forming the second layer of the roll cover and a melting point or less of the polymer.
